(19) United States
(12) Patent Application Publication
(10) Pub. No.: US 2015/0130309 A1
(43) Pub. Date: May 14, 2015

(54) STARTER FOR A COMBUSTION ENGINE

(71) Applicant: VALEO EQUIPEMENTS ELECTRIQUES MOTEUR, Creteil Cedex (FR)

(72) Inventors: Maximilien Gentil, Corbas (FR); Alexandre Saltel, Bron (FR)

(21) Appl. No.: 14/401,424

(22) PCT Filed: May 16, 2013
(86) PCT No.: PCT/FR2013/051070

§ 371 Date: Nov. 14, 2014

(30) Foreign Application Priority Data
May 16, 2012 (FR) 1254485

(51) Int. Cl. F02N 11/08; H02K 7/116

(52) U.S. Cl. CPC F02N 11/0851; H02K 7/116
USPC 310/83

(57) ABSTRACT

A starter motor (1) for a heat engine of a motor vehicle, comprising: an electric motor having a stator (7) and a rotor (3) mounted on a rotor shaft (5); a translatably mobile starter shaft (15) carrying a drive pinion (13) that can move from an idle position wherein the drive pinion (13) is released from a rotational element connected to the crankshaft of the heat engine to an active position wherein the drive pinion (13) is used to rotatably drive the rotational element connected to the crankshaft of the heat engine; and a speed reducer group (17) inserted between the rotor shaft (5) and the starter shaft (15).

### TECHNICAL FIELD OF THE INVENTION

The invention relates to a starter with a launcher provided with a free wheel which is immobile in translation. The invention has particularly advantageous, but not exclusive, application for vehicles which are equipped with the function of stopping and restarting of the thermal engine (the so-called “stop and start” function), according to which the thermal engine of the vehicle is stopped because of traffic conditions (in particular when stopping at a red light), and then restarted in such a way as to make fuel savings.

### PRIOR ART

In order to start a thermal engine, also known as an internal combustion engine, in particular of a motor vehicle, it is known to use a rotary electrical machine in the form of a starter provided with a launcher which can transmit rotation energy from the starter to a crankshaft of the thermal engine by means of a drive crown.

The launcher is mounted such as to slide on a drive shaft in relation with the shaft of the electrical machine by means of a reducer assembly. For this purpose, the launcher comprises a drive pinion and a free wheel, in general of the free wheel type with rollers, which is mounted on the drive shaft, and is configured to be activated by the control lever. More specifically, the free wheel comprises a sleeve which is connected to the drive shaft by means of a helical connection, the control lever being connected to the sleeve. The sleeve is integral with the front of a flange with orientation which is transverse relative to the axis of the drive shaft. This flange is integral on its outer perimeter with a bush with axial orientation, which, in combination with washers, forms a cage for the rollers of the free wheel which co-operates with the body of the pinion which forms the output of the free wheel.

A configuration of this type poses problems of endurance for starters used with the stop and start technology, which need to be able to function for a very large number of cycles. In fact, premature wear of the free wheel is observed since the wheel is mounted with play on the drive shaft by means of the helical connection. In fact, this play generates vibrations when the free wheel rotates, which tend to wear the internal elements of the free wheel, in particular the rollers, irrespective of whether the starter is functioning in overspeed mode or not. In addition, the fact that the free wheel forms part of the mass to be displaced by the control lever involves strong inertia of the launcher, and requires a contactor which is sufficiently powerful to displace this assembly of elements.

### OBJECT OF THE INVENTION

In order to solve this problem of endurance, the invention proposes an architecture in which the free wheel is connected at the output of the reducer, and is retained such as to be immobile in translation relative to the casing of the starter. According to this configuration, the control lever ensures the displacement of a launcher shaft which supports the pinion mounted on the drive shaft via a helical connection. The invention thus makes it possible to reduce the inertia of the launcher constituted solely by the pinion and the pinion body. In addition, the play of the free wheel is reduced because of its retention by the casing. Thus, the contactor can have a smaller dimension, since the power necessary in order to displace the launcher shaft is reduced.

For this purpose, the invention relates to a starter for a thermal engine of a motor vehicle, comprising:
an electric motor with a stator and a rotor mounted on a rotor shaft;
a launcher shaft which is mobile in translation, and supports a drive unit which can go from a position of rest in which the drive unit is released from a rotary element connected to the crankshaft of the thermal engine, to an active position in which the drive unit is designed to rotate the rotary element connected to the crankshaft of the thermal engine;
a speed reducer assembly which is interposed between the rotor shaft and the launcher shaft,

characterised in that it additionally comprises:
a free wheel which is immobile in translation with an input end connected in rotation to the speed reducer assembly, and an output end formed by a drive shaft;
the launcher shaft being mounted such as to be mobile in translation on the drive shaft by means of a helical connection.

According to one embodiment, the output end is constituted by a drive shaft.

According to one embodiment, the launcher shaft surrounds the drive shaft.

According to one embodiment, the starter comprises a base plate which is integral with the casing, the input end of the free wheel comprising a sleeve with an outer annular surface which is supported on an annular surface of an opening provided in the base plate, by means of a bearing which permits the rotation of the sleeve relative to the base plate, such as to ensure radial retention of the input end of the free wheel in the interior of the starter. This makes it possible to improve the mechanical strength of the input of the free wheel by reducing deflections and vibrations of the section between the rollers and the reducer, and thus to improve the service life of the free wheel.

According to one embodiment, the drive shaft is supported on an inner annular surface of the sleeve by means of a bearing which permits the rotation of the drive shaft relative to the sleeve, such as to ensure radial retention of the drive shaft in the interior of the starter.

By this means, the drive shaft is retained radially relative to the casing of the starter. The fact that the input of the free wheel and the output of the free wheel formed by an end of the drive shaft are retained radially in the casing, makes it possible to have a free wheel which is retained radially. This retention has the effect of increasing the service life of a free wheel.

According to one embodiment, the starter comprises a base plate which is integral with the casing, the input end of the free wheel comprising a flange which extends transversely relative to an axis of rotation of the free wheel, this flange having a transverse surface which is supported against a transverse surface of the base plate, such as to ensure axial retention of the input end of the free wheel in the interior of the starter.

According to one embodiment, the drive shaft comprises an annular protuberance with a transverse surface which is supported on a transverse surface of the flange, axially opposite the transverse surface of the flange which is supported against the base plate, such as to ensure axial retention of the drive shaft in the interior of the starter.

According to one embodiment, with the drive unit situated in the interior of the casing of the starter, the drive shaft is mounted on a bearing of the starter comprising a roller bearing.

According to one embodiment, with the drive unit situated on the exterior of the casing of the starter, the launcher shaft is mounted on a bearing of the starter, with the drive shaft ensuring axial guiding of the launcher shaft.

According to one embodiment, the launcher shaft comprises a blind bore with a form complementary to a first cylindrical portion of the drive shaft, with the drive shaft comprising a second cylindrical portion with a diameter larger than that of the first cylindrical portion, the second cylindrical portion of the drive shaft comprising ribbing which co-operates with grooves provided in the launcher shaft with a complementary form, in order to form the helical connection.

According to one embodiment, the speed reducer assembly is a planetary gear train comprising a crown secured on the casing of the starter, a planetary gear formed by an end of the rotor shaft, and a satellite holder comprising satellites which engage firstly with the crown, and secondly with the planetary gear, the input end of the free wheel being integral in rotation with the satellite holder according to the axis of the planetary gear.

According to one embodiment, one of the shafts out of the rotor shaft and the drive shaft penetrates partially axially into the other shaft.

According to one embodiment, the starter comprises a roller bearing unit, which is mounted between the two shafts, in order to allow the shaft which penetrates in the other shaft to be supported by the said other shaft.

According to one embodiment, the input end of the free wheel comprises a radial rim which extends towards the axis of the said free wheel, this radial rim being supported on the rotor shaft by means of a bearing.

According to one embodiment, the launcher shaft comprises a torque limiter installed between a fork which belongs to a system for displacement of the starter, and a part of the launcher shaft which supports the drive unit.

According to one embodiment, the launcher shaft is made of two parts, each of which supports a radial collar, and the torque limiter is formed by friction discs in contact with another, these friction discs being connected alternately in rotation with one of the parts of the launcher shaft and a connection unit, a washer of the Belleville type being situated at an end of the stack of friction discs supported against one of the radial collars.

According to one embodiment, the connection unit has an annular hollow delimited by two transverse walls, in the interior of which there are positioned the assembly of the friction discs and the collars, the transverse walls of the connection unit being placed against the transverse surfaces of the collars opposite the stack of friction discs.

According to one embodiment, one of the parts of the launcher shaft which supports the drive unit is without helical grooves, and helical grooves are provided only in the other part of the launcher shaft.

The drive unit is a drive pinion.

### BRIEF DESCRIPTION OF THE FIGURES

The invention will be better understood by reading the following description, and examining the figures which accompany it. These figures are provided purely by way of non-limiting illustration of the invention. The figures show the following:

FIG. 1 shows, according to a view in longitudinal cross-section, a first embodiment of the starter according to the invention, in which the drive pinion is situated in the interior of the starter;

FIG. 2 shows, according to a view in longitudinal cross-section, the front part of a starter produced according to a second embodiment, in which the drive pinion is situated on the exterior of the starter;

FIG. 3 shows, according to a view in longitudinal cross-section, a variant embodiment of the starter according to the invention, in which the launcher shaft comprises a torque limiter;

FIG. 4 shows a detailed view of the torque limiter of the starter in FIG. 3.

Elements which are identical, similar or analogous retain the same reference from one figure to another.

### DESCRIPTION OF EMBODIMENTS OF THE INVENTION

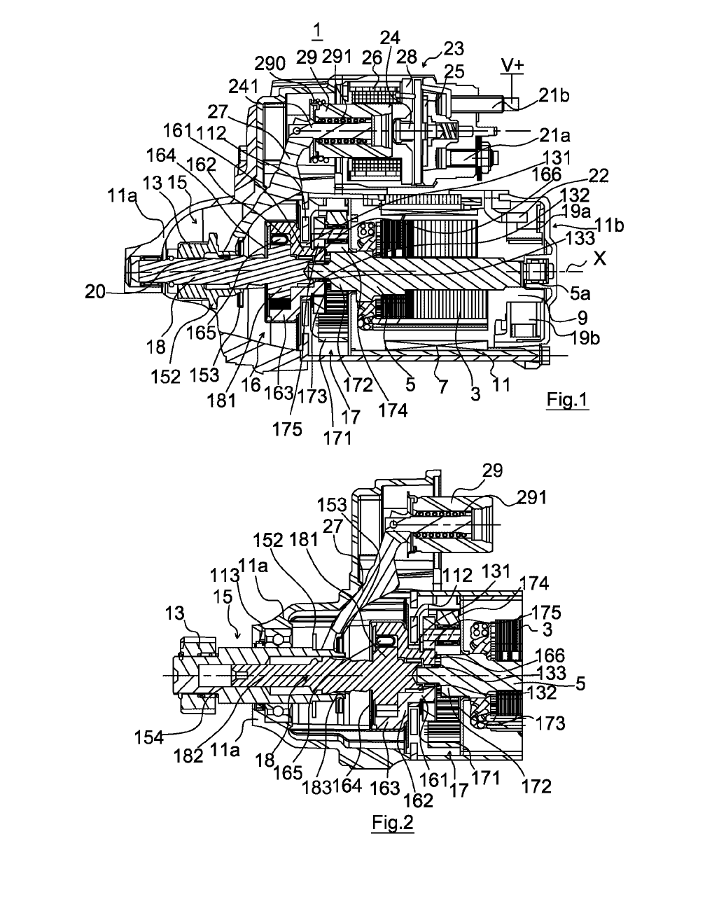

FIG. 1 shows an example of a started according to the invention in an active position. The starter 1 is of the “launcher” type. The starter 1 comprises an electric motor, comprising firstly a rotor 3, also known as an armature, mounted on a rotor shaft 5 which can rotate around its longitudinal axis X, and secondly a stator 7, also known as an inductor, installed around the rotor 3. The rotor shaft 5 has its rear end mounted in a roller bearing 5a of a bearing 11b at the rear of the starter 1 (known as the rear bearing).

Hereinafter in the description, the terms “front” and “rear” are, according to the longitudinal direction of the axis X of the rotor shaft 5, such that a front surface of a unit is the surface which faces a front bearing 11a, and the rear surface is the surface which faces the rear bearing 11b.

Behind the rotor 3, on the rotor shaft 5, there is mounted a collector 9 comprising contact parts which are connected electrically to the rotor 3.

The stator 7 is supported by a casing 111. The stator 7 can comprise a plurality of permanent magnets. As a variant, these magnets are replaced by electromagnets.

The starter 1 also comprises a pinion 13 which is mounted integrally in rotation with a launcher shaft 15. This launcher shaft 15 comprises a through hollow which permits the passage of a drive shaft 18. The launcher shaft 15 is connected to the drive shaft 18 by means of a helical connection 20. The drive shaft 18 has its front end mounted on the front bearing 11 a comprising one or more needle bearings. The launcher shaft 15 and the drive shaft 18 are coaxial according to the axis X.

The launcher shaft 15 is mounted on the drive shaft 18 such as to translate according to the axis X, relative to the drive shaft 18, from a position of rest to an active position which corresponds to the position represented in FIG. 1. In the active position, the pinion 13 is designed to rotate a toothed wheel which rotates a crankshaft of a thermal engine (not represented). In this case, the axis X of the drive shaft 18 is substantially the same as the axis X of the rotor shaft 5, but could be different, as in the examples described below.

The starter 1 additionally comprises a free wheel 16 as well as a speed reducer assembly 17, installed between the rotor shaft 5 and the drive shaft 18.

Thus, the reducer assembly 17 comprises a first end, known as the input end, which is connected to the rotor shaft 5, and another end, known as the output end, connected to the drive shaft 18 by means of the free wheel 16. In this case, the reducer assembly 17 is a planetary gear train comprising a fixed crown 171 which is connected to the casing 111, a planetary gear 172 corresponding to the input end of the reducer assembly 17 formed by the front end of the rotor shaft 5, and a satellite holder 173, corresponding to the output end of the reducer assembly comprising satellites 174 which engage firstly with the crown 171, and secondly with the planetary gear 172. The satellites 174 each comprise a shaft on which there is mounted at least one plate 175, which is integral in rotation with the input end of the free wheel 16, according to the axis of the planetary gear 172.

More specifically, the free wheel 16 comprises an input end which engages with the wheels 175, and an output end formed by the drive shaft 18. The free wheel 16 is kept immobile in translation, in particular by being supported on the casing 111.

For this purpose, the casing 111 comprises a base plate 112 which is integral with the casing 111, and extends transversely relative to the axis X. This base plate 112 is integral with the casing 111. Alternatively, the base plate 112 is added and secured on the inner wall of the casing 111. The base plate 112 is in the form of a plate comprising a through inner opening which permits the passage of a sleeve 161 of the free wheel 16.

The input end of the free wheel 16 comprises the sleeve 161, a through flange 162 which is integral with the front of the sleeve 161, and a bush 163 with axial orientation, which is integral with the outer periphery of the flange 162. In combination with washers 164, this bush 163 forms a cage for the rollers 165 of the free wheel 16 which co-operate with an angular protuberance 181 of the drive shaft 18.

Firstly, the sleeve 161 has an outer annular surface, which is supported on an annular surface of an opening provided in the base plate 112 by means of a bearing 131. Secondly, the sleeve 161 has an inner annular surface which is supported on the outer surface of the drive shaft 18 by means of a bearing 132. The bearings 131, 132 are formed for example by metal rings with a low thickness. The bearings 131, 132 permit relative rotation of the two elements between which the said bearings 131, 132 are installed. These bearings 131, 132 could be replaced in an equivalent manner by ball bearings. By this means, the drive shaft 18 is retained radially relative to the casing of the starter. The fact that the input of the free wheel and the output of the free wheel formed by an end of the drive shaft are retained radially in the casing makes it possible to obtain a free wheel which is retained radially. This retention has the effect of increasing the service life of a free wheel.

The flange 162 has a rear transverse surface supported on a front transverse surface of the base plate 112. The annular protuberance 181 comprises a rear transverse surface supported on a front transverse surface of the flange 162.

Thus, in a configuration of this type, the radial retention of the input end of the free wheel 16 is ensured by the inner annular surface of the base plate 112, against which the sleeve 161 is supported by means of the bearing 131. The axial retention of the input end of the free wheel 16 is ensured by the rear transverse surface of the flange 162 supported against the front transverse surface of the base plate 112.

The radial retention of the output of the free wheel 16 is ensured firstly by the front bearing 11a, in the interior of which the front end of the drive shaft 18 is installed; and secondly by the annular surface of the base plate 112, against which the rear end of the drive shaft 18 is supported by means of the bearing 132, of the sleeve 161, and of the bearing 131. The axial retention of the output of the free wheel 16 is ensured by the transverse surface of the annular protuberance 181 of the drive shaft 18 supported against the base plate 112 by means of the flange 162.

In addition, the input end of the free wheel 16 has at its rear end a radial rim 166 which extends towards the interior of the sleeve 161. This radial rim 166 is supported by means of a bearing 133 on a section of the rotor shaft 5 with a diameter smaller than that of the section of the drive shaft 18 which forms the planetary gear 172 of the planetary gear train.

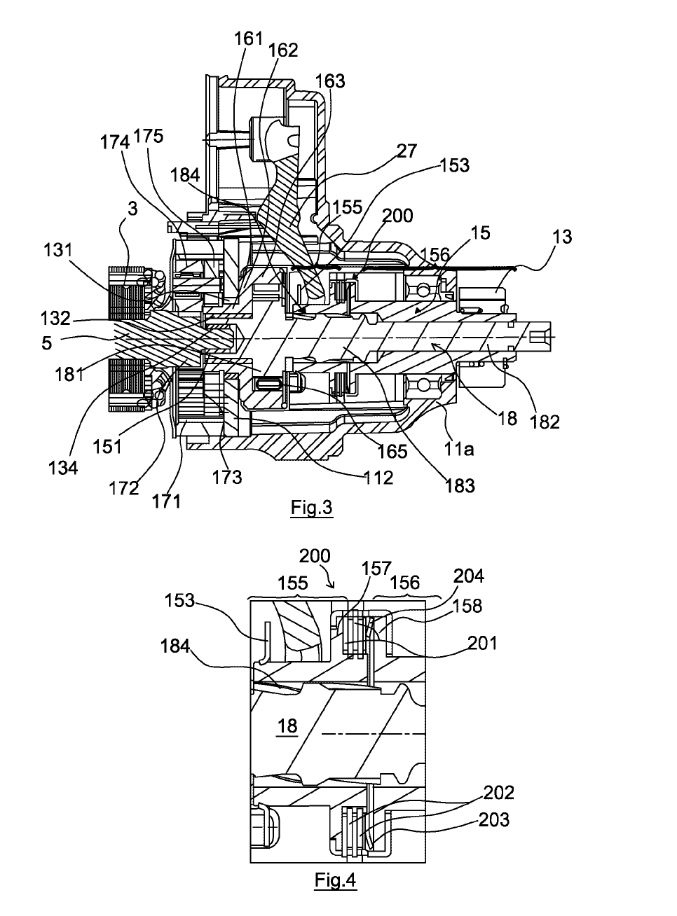

The drive shaft 18 penetrates axially partly in the interior of the rotor shaft 5 via a bore 151, or conversely. As shown in FIG. 3, the outer surface of the rotor shaft 5 can cooperate with the annular surface of the bore 151 provided in the drive shaft 18 by means of a bearing 134 which is fitted on the end of the rotor shaft 5. The fork 27 is installed between two radial rims 152, 153 of the launcher shaft 15.

FIG. 2 shows a second embodiment of the starter 1, in which the pinion 13 is situated on the exterior of the casing 111. According to this embodiment, the launcher shaft 15 which is mounted on the front bearing 11a passes through the casing 111 via an opening 113. In order to ensure the axial guiding of the launcher shaft 15, the said launcher shaft 15 comprises in its front part a blind bore 154 with a form complementary to a cylindrical portion 182 of the drive shaft 18. The drive shaft 18 also comprises a cylindrical portion 183 with a diameter larger than that of the first portion 182. In order to form the helical connection with the launcher shaft 15, the cylindrical portion 183 comprises ribbing 184 which can clearly be seen in FIG. 3, co-operating with grooves provided in the launcher shaft 15 with a complementary form, or conversely.

As previously, the fork 27 is installed between two radial rims 152, 153 of the launcher shaft 15. The free wheel 16 is retained radially and axially in the same manner as in the structure of the starter in FIG. 1.

According to an embodiment shown in FIGS. 3 and 4, the launcher shaft 15 comprises a torque limiter 200 which is installed between the fork 27 and a part of the launcher shaft 15 which supports the pinion 13. In this case, the launcher shaft 15 is made in two parts 155 and 156, each supporting a radial collar 157 and 158. The fork 27 is installed between the radial rim 153 and the collar 157. As can be seen clearly in FIG. 4, the torque limiter 200 is formed by friction discs 201, 202 in contact with one another. These friction discs 201, 202 are alternatively connected in rotation with the part 155 of the launcher shaft 15 and a connection unit 203. For this purpose, the friction discs 201, 202 comprise for example tongues which extend such as to co-operate radially with furrows with a complementary form provided in the part with which the discs 201, 202 are connected in rotation. A washer 204 of the Belleville type is situated at one end of the stack of discs 201, 202. Only the part 155 of the launcher shaft 15 comprises helical grooves so as to form the helical connection with the drive shaft 18. The part 156 which supports the drive pinion 13 does not comprise helical grooves, in order to permit its rotation in the case of excess torque, independently from the part 155, as explained hereinafter.

The connection unit 203 has an annular hollow delimited by two transverse walls, in the interior of which there are positioned the assembly of the friction discs 201, 202 and the collars 157 and 158. The transverse walls of the connection unit 203 are placed against transverse surfaces of the collars 157, 158, opposite the stack of friction discs 201, 202. The connection unit 203 is configured such that the washer 204 which is supported on the collar 158 exerts a force in the direction of the stack of discs 201, 202, whereas a reaction force is exerted on the collar 157 side, such as to compress the assembly of discs 201, 202. It will be appreciated that the torque limiter 200 could also be used with the starter 1 with an internal pinion in FIG. 1.

In normal functioning, the two parts 155, 156 are connected in rotation with one another as a result of the compression of the friction discs 201, 202 against one another. In the case of excess torque, the friction discs 201, 202 will slide on one another, such that the part 156 of the launcher shaft 15 will rotate on the shaft 18, without driving the part 155, which will make it possible to reduce the risks of breakage.

As a variant, the reducer assembly 17 can be any other type of reducer. For example, the reducer assembly 17 could comprise two toothed wheels, one of which is integral with the rotor shaft 5, and the other one of which is integral with the input end of the free wheel 16. In this example, the two axes of the rotor shaft 5 and the drive shaft 15 are offset in parallel. According to another example, the reducer system 17 can be with left-side gearing or with converging gearing. In these two types of reducer system 17, the axis of the drive shaft 15 and the axis of the rotor shaft 5 are respectively converging, or neither parallel nor converging.

The starter 1 additionally comprises a system for displacement of the launcher shaft 15, in order to make the pinion 13 pass from its position of rest to its active position, and vice versa. This displacement system comprises a contactor 23 and the fork 27 described hereinafter.

A set of brushes 19a and 19b is provided for the electrical supply of the winding of the rotor 3. At least one of the brushes 19b is connected electrically to the earth of the started, for example the casing 111, and at least another one of the brushes 19a is connected electrically to an electric terminal 21a of the contactor 23, for example via a wire 22. The brushes 19a and 19b rub on the collector 9 when the rotor 3 is rotating. The starter 1 can comprise a plurality of brushes.

In addition to the terminal 21a connected to the brush 19a, the contactor 23 comprises a terminal 2 lb which is designed to be connected via an electrical connection element to a positive electrical supply V+ of the vehicle, in particular a battery, not represented.

The contactor 23 comprises a mobile contact plate 25, to connect the terminals 21b and 21a electrically, in order to supply power to the electric motor. The contactor 23 can also activate the fork 27, in order to displace the launcher shaft 15 and the pinion 13 from the position of rest to the active position and vice versa. For this purpose, the contactor 23 also comprises a mobile core 29, a fixed core 28, a fixed coil 26, a mobile control rod 24, and a mobile rod 241.

The control rod 24 passes through the fixed core 28, which acts as a guide for it. This control rod 24 has its front end supported on the fixed core 28, and its rear end secured to the contact plate 25. The control rod 24 is subjected to the action of a compressed contact spring (with no reference), between a shoulder of the control rod 24 and the contact plate 25, in order to ensure electrical contact of the contact plate with the terminals 21a and 21b when the mobile core 29 is in a so-called magnetised position.

The mobile rod 241 is secured at its front end to the fork 27. When the coil 26 is supplied with power, the mobile core 29 is drawn towards the fixed core 28, until it is in the magnetised position. Its displacement drives simultaneously the mobile rod 241, the contact plate 25 and the control rod 24 rearwards. The mobile rod 241 is also subjected to a tooth-against-tooth spring 291 which is accommodated in the interior of the mobile core 29, and surrounds the mobile rod 241. This tooth-against-tooth spring 291 is supported on a front shoulder of the mobile rod 241, and a rear shoulder of the mobile core 29. This tooth-against-tooth spring 291 is compressed when the contact plate 25 is displaced towards the terminals 21b, 21a, and when the fork 27 can no longer make the pinion 13 advance. The fork 27 can no longer advance when the pinion 13 is blocked in translation according to the axis X in the direction of the toothed wheel connected with the crankshaft by one or more teeth of the said toothed wheel. This blocked state is known as the “tooth-against-tooth position”. The compression of the tooth-against-tooth spring 291 makes it possible to absorb the impacts, whilst applying a force on the fork 27 which is transmitted to the pinion 13, towards the engagement position.

The contactor 23 additionally comprises a return spring 290 which is supported on the fixed coil 26 and the mobile core 29, in order to thrust it forwards to its position of rest, and simultaneously to displace the fork 27 until the pinion 13 is in the position of rest.

1. Starter (1) for a thermal engine of a motor vehicle, comprising:
an electric motor with a stator (7) and a rotor (3) mounted on a rotor shaft (5);
a launcher shaft (15) which is mobile in translation, and supports a drive unit (13) which can go from a position of rest in which the drive unit (13) is released from a rotary element connected to the crankshaft of the thermal engine, to an active position in which the drive unit (13) is designed to rotate the rotary element connected to the crankshaft of the thermal engine;
a speed reducer assembly (17) which is interposed between the rotor shaft (5) and the launcher shaft (15),
wherein it additionally comprises:
a free wheel (16) which is immobile in translation with an input end connected in rotation to the speed reducer assembly (17), and an output end formed by a drive shaft (18);
the launcher shaft being (15) mounted such as to be mobile in translation on the drive shaft (18) by means of a helical connection.

2. Starter according to claim 1, characterized in that it comprises a base plate (112) which is integral with the casing (111), the input end of the free wheel (16) comprising a sleeve (161) with an outer annular surface which is supported on an annular surface of an opening provided in the base plate (112), by means of a bearing (131) which permits rotation of the sleeve (161) relative to the base plate (112), such as to ensure radial retention of the input end of the free wheel (16) in the interior of the starter.

3. Starter according to claim 2, characterized in that the drive shaft (18) is supported on an inner annular surface of the sleeve (161) by means of a bearing (132) which permits rotation of the drive shaft (18) relative to the sleeve (161), such as to ensure radial retention of the drive shaft (18) in the interior of the starter.

4. Starter according to claim 1, characterized in that it comprises a base plate (112) which is integral with the casing (111), the input end of the free wheel comprising a flange (162) which extends transversely relative to an axis of rotation (X) of the free wheel (16), this flange (162) having a transverse surface which is supported against a transverse surface of the base plate (112), such as to ensure axial retention of the input end of the free wheel (16) in the interior of the starter.

5. Starter according to claim 4, characterized in that the drive shaft (18) comprises an annular protuberance (181) with a transverse surface which is supported on a transverse surface of the flange (162), axially opposite the transverse surface of the flange which is supported against the base plate (112), such as to ensure axial retention of the drive shaft (18) in the interior of the starter.

6. Starter according to claim 1, characterized in that, with the drive unit (13) situated in the interior of the casing (111) of the starter, the drive shaft (18) is mounted on a bearing (11a) of the starter comprising a roller bearing.

7. Starter according to claim 1, characterized in that, with the drive unit (13) situated on the exterior of the casing (111) of the starter, the launcher shaft (15) is mounted on a bearing of the starter, with the drive shaft (18) ensuring axial guiding of the launcher shaft (5).

8. Starter according to claim 7, characterized in that the launcher shaft (15) comprises a blind bore (154) with a form complementary to a first cylindrical portion (182) of the drive shaft (18), with the drive shaft (18) comprising a second cylindrical portion (183) with a diameter larger than that of the first cylindrical portion (182), the second cylindrical portion (183) of the drive shaft comprising ribbing which co-operates with grooves provided in the launcher shaft (15) with a complementary form, in order to form the helical connection.

9. Starter according to claim 1, characterized in that the speed reducer assembly (17) is a planetary gear train comprising a crown (171) secured on the casing of the starter, a planetary gear (172) formed by an end of the rotor shaft (5), and a satellite holder comprising satellites which engage firstly with the crown, and secondly with the planetary gear (172), the input end of the free wheel (16) being integral in rotation with the satellite holder according to the axis of the planetary gear (172).

10. Starter according to claim 1, characterized in that one of the shafts out of the rotor shaft (5) and the drive shaft (18) penetrates partially axially into the other shaft.

11. Starter according to claim 10, characterized in that it comprises a roller bearing unit (132), which is mounted between the two shafts (5, 18), in order to allow the shaft which penetrates in the other shaft to be supported by the said other shaft.

12. Starter according to claim 2, characterized in that the input end of the free wheel (16) comprises a radial rim (166) which extends towards the axis of the said free wheel (16), this radial rim (166) being supported on the rotor shaft (5) by means of a bearing (133).

13. Starter according to claim 1, characterized in that the launcher shaft (15) comprises a torque limiter (200) installed between a fork (27) which belongs to a system for displacement of the starter, and a part of the launcher shaft (15) which supports the drive unit.

14. Starter according to claim 13, characterized in that the launcher shaft (15) is made of two parts (155, 156), each of which supports a radial collar (157, 158), and the torque limiter (200) is formed by friction discs (201, 202) in contact with another, these friction discs (201, 202) being connected alternately in rotation with one of the parts (155, 156) of the launcher shaft (15) and a connection unit (203), a washer (204) of the Belleville type being situated at an end of the stack of friction discs (201, 202) supported against one of the radial collars (157, 158).

15. Starter according to claim 14, characterized in that the connection unit (203) has an annular hollow delimited by two transverse walls, in the interior of which there are positioned the assembly of the friction discs (201, 202) and the collars (157, 158), the transverse walls of the connection unit (203) being placed against the transverse surfaces of the collars (157, 158) opposite the stack of friction discs (201, 202).

16. Starter according to claim 14, characterized in that one of the parts (156) of the launcher shaft (15) which supports the drive unit (13) is without helical grooves, and helical grooves are provided only in the other part (155) of the launcher shaft (15).

17. Starter according to claim 2, characterized in that it comprises a base plate (112) which is integral with the casing (111), the input end of the free wheel comprising a flange (162) which extends transversely relative to an axis of rotation (X) of the free wheel (16), this flange (162) having a transverse surface which is supported against a transverse surface of the base plate (112), such as to ensure axial retention of the input end of the free wheel (16) in the interior of the starter.

18. Starter according to claim 3, characterized in that it comprises a base plate (112) which is integral with the casing (111), the input end of the free wheel comprising a flange (162) which extends transversely relative to an axis of rotation (X) of the free wheel (16), this flange (162) having a transverse surface which is supported against a transverse surface of the base plate (112), such as to ensure axial retention of the input end of the free wheel (16) in the interior of the starter.

19. Starter according to claim 2, characterized in that, with the drive unit (13) situated in the interior of the casing (111) of the starter, the drive shaft (18) is mounted on a bearing (11a) of the starter comprising a roller bearing.

20. Starter according to claim 3, characterized in that, with the drive unit (13) situated in the interior of the casing (111) of the starter, the drive shaft (18) is mounted on a bearing (11a) of the starter comprising a roller bearing.

21. Starter according to claim 4, characterized in that, with the drive unit (13) situated in the interior of the casing (111) of the starter, the drive shaft (18) is mounted on a bearing (11a) of the starter comprising a roller bearing.

22. Starter according to claim 5, characterized in that, with the drive unit (13) situated in the interior of the casing (111) of the starter, the drive shaft (18) is mounted on a bearing (11a) of the starter comprising a roller bearing.
